(19) United States
(12) Patent Application Publication
(10) Pub. No.: US 2026/0328442 A1
(43) Pub. Date: Oct. 22, 2026

(54) SORPTION HEAT TRANSFORMER AND THERMAL STORAGE

(71) Applicant: SIMON FRASER UNIVERSITY, Burnaby (CA)

(72) Inventor: Majid BAHRAMI, North Vancouver (CA)

(21) Appl. No.: 19/115,748

(22) PCT Filed: Sep. 28, 2023
(86) PCT No.: PCT/CA2023/051290

§ 371 Date: Mar. 26, 2025

(30) Foreign Application Priority Data
Sep. 29, 2022 (CA) 3177348

(51) Int. Cl. F25B 17/08; F25B 39/00; F25B 39/02; F25B 39/04

(52) U.S. Cl. CPC F25B 17/08; F25B 39/00; F25B 39/026; F25B 39/04; F25B 2315/005; F25B 2400/24

(57) ABSTRACT

A sorption device includes a sorber bed chamber having a sorbent material disposed therein and configured to sorb and desorb vapor from a refrigerant. The sorber bed chamber is configured to exchange heat with a regenerative fluid to effect desorption of the refrigerant from the sorbent material. The sorption device also includes an evaporator and condenser fluidly coupled to the sorber bed chamber and configured to evaporate the refrigerant for sorption by the sorbent material of the sorber bed, and configured to condense vapor from the sorbent material of the sorber bed. The sorber bed chamber, the evaporator and condenser are configured to provide a sealed refrigerant flow path.

### FIELD OF TECHNOLOGY

The present disclosure relates generally to sorption devices for use in, for example, thermal energy storage, heating, cooling, or a combination thereof utilizing a low grade heating source. Examples of such devices include heat transformers, thermal battery, and heat pumps.

### BACKGROUND

Roughly 90% of global energy use involves generating or manipulating heat. About 60% of that heat is discharged to the ambient as low-grade heat, i.e., heat with temperatures below 100° C. Recovery or use of that heat in heating, cooling, or industrial processes, represents a significant energy savings and environmental benefit.

Sorption devices utilize a sorbent material to absorb or adsorb a refrigerant. Such devices are utilized to provide heating and cooling with low electrical power consumption. A cooling effect is generated by the uptake of the refrigerant by the sorbent material, such as hygroscopic salts in a porous host matrix, driving evaporation and transferring heat at the evaporator. The heat of sorption is dissipated from the sorber bed to the environment during the regeneration process. In the regeneration phase of the cycle, the sorbent is regenerated (dried) using low-grade heat from a source which is preferably renewable such as solar heat, geothermal, or industrial waste-heat. The operation of the sorption device is cyclic as the refrigerant is adsorbed, desorbed (by heating it), and pressurized in the same container. Continuous output may be achieved utilizing multiple sorber beds.

Heating may be generated as the heat transformers operate as heat pumps, upgrading ambient (e.g., geothermal or environment) heat for space/water heating systems (or other applications) with a temperature lift of up to ΔT≈30° C. Sorption heat transformers also facilitate thermal storage (heat or cold) with low energy loss, enabling long-term or seasonal thermal storage, referred to herein as thermal battery application.

Existing sorption devices are generally large or bulky leading to high costs, with relatively low coefficient of performance (COP) for heating of between 1 and 1.3, and for cooling of between 0.5 and 0.6 depending on the operating conditions.

These bulky and costly systems are susceptible to corrosion in the sorber beds and heat exchangers. In addition, the generation of non-condensable gases and leaks lead to frequent maintenance to maintain a low vacuum in the range of about 1 to 4 kPa. Further, relatively large or bulky systems are utilized for heating or cooling or thermal storage applications resulting in low energy storage density at the system level.

Improvements in sorption heat transformer and thermal storage devices are desirable.

### SUMMARY

According to one aspect of an embodiment, a sorption device is provided. The sorption device includes a sorber bed chamber having a sorbent material disposed therein and configured to sorb and desorb vapor from a refrigerant. The sorber bed chamber is configured to exchange heat with a regenerative fluid to effect desorption of the refrigerant from the sorbent material. The sorption device also includes an evaporator and condenser fluidly coupled to the sorber bed chamber and configured to evaporate the refrigerant for sorption by the sorbent material of the sorber bed, and configured to condense vapor from the sorbent material of the sorber bed. The sorber bed chamber, the evaporator and condenser are configured to provide a sealed refrigerant flow path.

### BRIEF DESCRIPTION OF THE DRAWINGS

Embodiments of the present disclosure will now be described, by way of example only, with reference to the attached figures, in which:

FIG. 1 is schematic view of an example of a sorption device in accordance with an embodiment;

FIG. 2 is a schematic view of an example of a sorption device in accordance with another embodiment;

FIG. 3 is a perspective view of a sorber bed chamber of a sorption device in accordance with an embodiment;

FIG. 4 shows an end view of the tube of FIG. 3;

FIG. 5 shows a sectional side view of the tube of FIG. 4;

FIGS. 6A and 6B show a side view and a sectional view of the sorber bed chamber of FIG. 3 illustrating one example of a sorbent material;

FIGS. 7A and 7B show a side view and a sectional view of the sorber bed chamber of FIG. 3 illustrating another example of a sorbent material;

FIGS. 8A and 8B show a side view and a sectional view of the sorber bed chamber of FIG. 3 illustrating yet another example of a sorbent material;

FIG. 9 is a perspective view of a sorber bed chamber of a sorption device in accordance with another embodiment;

FIG. 10 shows an end view of the sorber bed chamber of FIG. 9;

FIG. 11 shows a sectional side view of the sorber bed chamber of FIG. 9;

FIG. 12 is a perspective view of a bundle of sorber bed chambers in a parallel arrangement in accordance with an embodiment;

FIG. 13 is a perspective view of a housing with a bundle of sorber bed chambers housed therein in accordance with an embodiment;

FIG. 14 is a sectional view taken from an end of the housing with the bundle of sorber bed chambers of FIG. 12;

FIG. 15 is a sectional view taken from a top of the housing including the sorber bed chambers of FIG. 12;

FIG. 16 is a sectional view taken from a side of housing including the sorber bed chambers of FIG. 12;

FIG. 17 is a perspective view of a housing including a bundle of sorber bed chambers in accordance with another embodiment;

FIG. 18 is a sectional view taken from an end of the housing including the bundle of sorber bed chambers of FIG. 17;

FIG. 19 is a sectional view taken from a top of the housing including the bundle of sorber bed chambers of FIG. 17;

FIG. 20 is a sectional view taken from a side of the housing including the sorber bed chambers of FIG. 17;

FIG. 21 is a perspective view illustrating an example of a sorption device in accordance with an embodiment;

FIG. 22 is an end view of the sorption device of FIG. 21, showing hidden detail;

FIG. 23 is a top view of the sorption device of FIG. 21, showing hidden detail;

FIG. 24 is a side view of the sorption device of FIG. 21, showing hidden detail;

FIG. 25 is a perspective view of an example of a combination of sorption devices in accordance with an embodiment;

FIG. 26 is an image showing one example of a sorbent material for use in a sorption device in accordance with embodiment;

FIG. 27 is an image showing one example of a surface of an evaporator of a sorption device in accordance with an embodiment; and

FIG. 28 is an image showing one example of a surface of a condenser of a sorption device in accordance with an embodiment.

### DETAILED DESCRIPTION

For simplicity and clarity of illustration, reference numerals may be repeated among the figures to indicate corresponding or analogous elements. Numerous details are set forth to provide an understanding of the examples described herein. The examples may be practiced without these details. In other instances, well-known methods, procedures, and components are not described in detail to avoid obscuring the examples described. The description is not to be considered as limited to the scope of the examples described herein.

A sorption device includes a sorber bed chamber that has a sorbent material fixed on an internal surface of a wall thereof and configured to sorb and desorb vapor from a refrigerant. The sorber bed chamber is configured to exchange heat with a regenerative fluid to effect desorption of the refrigerant from the sorbent material. An evaporator and condenser fluidly coupled to the sorber bed chamber and configured to evaporate the refrigerant for sorption by the sorbent material of the sorber bed and configured to condense vapor from the sorbent material of the sorber bed. The sorber bed chamber, the evaporator and condenser are configured to provide a sealed refrigerant flow path.

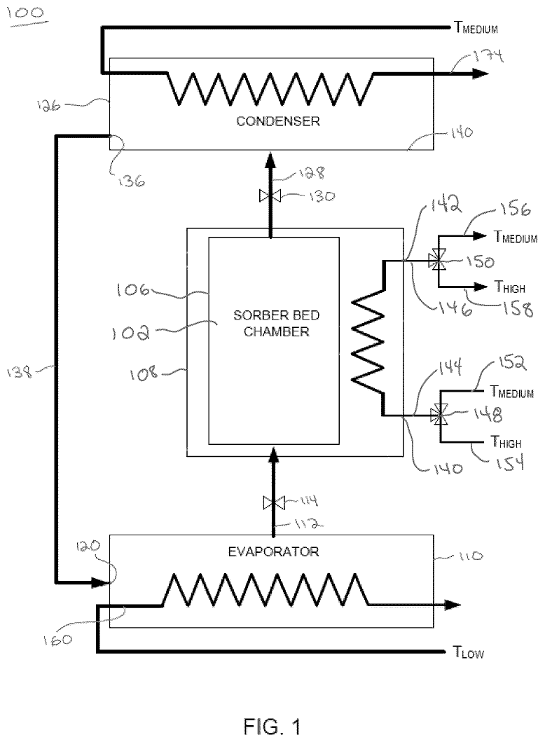

Reference is made to FIG. 1 which shows a schematic view of an example of a sorption device 100. In the present example, the sorption device 100 includes one sorber bed chamber 102. Additional sorber bed chambers may be successfully implemented, however. The sorber bed chamber 102 has a sorbent material fixed to an internal surface of a wall 106 of the sorber bed chamber 102. The sorbent material is suitable to sorb and desorb the refrigerant in its vapor from. The wall 106 of the sorber bed chamber 102 may be a thin-walled material that is metallized or metal-lined or made from other materials such as graphite, polymer, ceramic, glass, or any combination thereof with a thin coating and/or resin impregnation or any combination thereof. Optionally, a coating may be utilized to protect the surface against corrosion. Optionally, resin impregnation may be used to seal the surface pores in porous or semi-porous wall materials such as graphite. In one example, the wall 106 of the sorber bed chamber 102 is a thin-walled metallic-polymer package or pouch.

The sorbent material is highly porous and has a relatively high thermal conductivity, low density, and low specific heat. For example, the sorbent material may have a specific pore volume of >1 cm³/g and specific surface area of >300 m²/g. The thermal conductivity may be greater than 0.2 W/mK. In some examples, the thermal conductivity may be greater than 1.5 W/mK. The sorbent material may include a solid sorbent, a binder material, hygroscopic salt, and a conductive additive. The sorbent material has high gas diffusivity to facilitate permeation of the vapor into and out of the sorbent material. In one example, the solid sorbent of the sorbent material includes a highly porous matrix of, for example, silica gel, as the host. The host matrix is impregnated by hygroscopic salts such as calcium chloride or lithium bromide and is loaded with one or more types of suitable thermally conductive additive material such as graphite flakes, treated and modified expanded natural graphite, graphite worms, carbon nanotubes, or a combination thereof. A binder material of organic glue, inorganic glue, or liquid glass may be utilized to bind the elements together into a composite. In one example, a binder of Polyvinylpyrrolidone 40 (PVP40), is utilized to bind the elements together into a composite. In a particular example, the sorbent material is silica gel (B300) 58%; CaCl₂): 25%; Expanded natural graphite: 8%; PVA: 9%.

The sorber bed chamber 102 is housed in a housing 108 that extends around the sorber bed chamber 102. The wall 106 of the sorber bed chamber 102 provides a barrier between the interior of the sorber bed chamber 102 and the exterior of the sorber bed chamber 102. Thus, the sorber bed chamber 102 is hermetically sealed from a remainder of the interior of the housing 108 that surrounds the sorber bed chamber 102.

The sorber bed chamber 102 is fluidly coupled to an evaporator 110 by a fluid line 112 for the flow of vapor from the evaporator 110 into the sorber bed chamber 102. The fluid line 112 extends through the housing 108 and into the sorber bed chamber 102, maintaining a seal or barrier between operating fluid in the fluid line 112 and the remainder of the interior of the housing 108 that surrounds the sorber bed chamber 102. The fluid line 112 includes a valve 114 to control the flow of vapor from the evaporator 110 into the sorber bed chamber 102.

The evaporator 110 is configured to operate at a suitable pressure for evaporation of the refrigerant. The pressure may be a low pressure, i.e., a pressure well below atmospheric pressure. The pressure at which the evaporator operates at is dependent on the refrigerant utilized, operating conditions, and the application, for example, thermal storage, heating, or air conditioning. The evaporator 110 includes an inlet 120 for receiving the refrigerant into the evaporator 110. Internal surfaces 122 of the evaporator 110 include a surface pattern or modification to facilitate capillary action of the refrigerant within the evaporator 110. The surface pattern or modification on the internal surfaces may be micro-grooves or may include the use of a wick, or both, that are sized to facilitate wicking of the refrigerant, providing super-hydrophilic surfaces. The grooves may be formed utilizing any suitable technique such as molding, coating, spraying, stamping, laser machining, etching, deposition, bead-blasting, bonding structures (such as micropillars, mesh, a porous structure), or a combination of these techniques.

The sorber bed chamber 102 is also fluidly coupled to a condenser 126 by a vapor line 128 for the flow of vapor from the sorber bed chamber 102 to the condenser 126. The vapor line 128 extends through the housing 108, from the sorber bed chamber 102 and into the condenser 126, maintaining a seal or barrier between operating fluid in the vapor line 128 and the remainder of the interior of the housing 108 that surrounds the sorber bed chamber 102. The vapor line 128 includes a valve 130 to control the flow of vapor from the sorber bed chamber 102 into the condenser 126.

The condenser 126 is configured to condense the vapor from the sorber bed chamber 102 at a pressure that is higher than the pressure in the evaporator 110. In particular, the condenser 126 is configured to operate at a pressure that is suitable for the refrigerant to condense. The operating pressure in the condenser 126 is therefore dependent on the refrigerant, operating conditions, and the application. The condenser 126 includes a condenser outlet 136 for the flow of condensate from the condenser 126. The condenser outlet 136 is fluidly coupled to the evaporator inlet 120 by a refrigerant return line 138 for the return of the liquid refrigerant to the evaporator inlet 120.

Internal condenser surfaces 140 include a surface pattern or modification to facilitate capillary action of the refrigerant within the condenser 126. The surface pattern or modification may be asymmetric bumps on the internal condenser surfaces 140 to facilitate drop-wise condensation. The bumps may be formed utilizing any suitable technique such as molding, coating, spraying, stamping, laser machining, etching, deposition, bonding structures (such as micropillars, mesh, a porous structure), or a combination of these techniques.

Similar to the sorber bed chamber 202, the outer wall of each of the evaporator 110 and the condenser 126 may be made of a thin-walled material that is metallized or metal-lined or made from other materials such as graphite, polymer, ceramic, glass, with thin coating and/or resin impregnation, or any combination thereof. Optionally, a coating may be utilized to protect the surface against corrosion and/or to modify or enhance the surface features such as contact angle. Optionally, resin impregnation may be used to seal the surface pores in porous and semi-porous wall materials such as graphite. In one example, each wall is a thin-walled metallic-polymer package or pouch.

The housing 108 around the sorber bed chamber 102 includes a heat exchange fluid inlet 140 and a heat exchange fluid outlet 142. The heat exchange fluid inlet 140 is coupled to a heat exchange fluid inlet line 144 that includes a three-way inlet valve 148 for selectively coupling the heat exchange fluid inlet line 144 to a first inlet line 152 and a second inlet line 154. The heat exchange fluid outlet 142 is coupled to a heat exchange fluid outlet line 146 that includes a three-way outlet valve 150 for selectively coupling the heat exchange fluid outlet line 146 to a first outlet line 156 and a second outlet line 158. The first inlet line 152 and first outlet line 156 may be utilized for the flow of a cooling fluid utilized to cool the sorber bed chamber 102 during sorption of the vapor from the evaporator to facilitate sorption by the sorber bed chamber 102 as the heat of sorption is generated. The cooling fluid may be, for example, ambient temperature water or water from a cooling tower, lake, or other source. Turbulators or flappers or both may be utilized in the housing 108 to facilitate effective heat transfer.

The second inlet line 154 and the second outlet line 158 may be utilized for the flow of a regenerative heat exchange fluid to heat the sorber bed chamber 102 to facilitate desorption of the refrigerant vapor into the condenser 126. The regenerative fluid utilized to heat the sorber bed chamber 102 may be waste gasses from industry, solar heated fluid, geothermal heated fluid, or any other low grade heat fluid.

Thus, the cooling fluid may be an ambient temperature fluid that is introduced into the housing 108 via the first inlet line 152, the three-way inlet valve 148, and the heat exchange fluid inlet line 144 to exchange heat with the sorber bed chamber 102, to cool the sorbent material during sorption of the refrigerant vapor. The cooling fluid exits the housing 108 via the heat exchange fluid outlet line 146, the three-way outlet valve 150, and the first outlet line 156.

The regenerative fluid may be a waste gas or other low grade heat fluid that is selectively introduced into the housing 108 via the second inlet line 154, the three-way inlet valve 148, and the heat exchange fluid inlet line 144, to exchange heat with the sorber bed chamber 102, to heat the sorbent material in the sorber bed chamber 102. This heat exchange is utilized to facilitate desorption of the refrigerant from the sorbent material in the sorber bed chamber 102, thus regenerating the sorbent material to receive more vapor from the evaporator. The regenerative fluid exits the housing 108 via the heat exchange fluid outlet line 146, the three-way outlet valve 150, and the second outlet line 158.

A fluid cooling line 160 is shown in FIG. 1 and extends through the evaporator 110, through a housing that houses an evaporator chamber, releasing heat from a fluid therein as the fluid passes through the fluid cooling line 160 in the evaporator 110. The refrigerant that enters the evaporator 110 through the evaporator inlet 120 is maintained separate from fluid in the fluid cooling line 160. As the refrigerant evaporates under low pressure in the evaporator 110, withdrawn cooling effect is generated in the evaporator 110 as the refrigerant evaporates. The vapor from the refrigerant enters the sorber bed chamber and is sorbed by the sorption material. Fluid traveling through the fluid cooling line 160 is thereby cooled as the fluid travels in the evaporator 110. Turbulators or flappers or both may be utilized to keep the moving fluid in turbulence to ensure effective heat transfer. The fluid may be any suitable fluid, such as water, and may be utilized in cooling applications such as air conditioning.

A heating fluid line 174 extends through the condenser 126, through a housing that houses a condenser chamber, and is maintained separate from the refrigerant that condenses in the condenser 126. Heating fluid travelling through the condenser 126 in the heating fluid line 174 may be heated as the refrigerant condenses in the condenser 126. The heating fluid line the exits the condenser 126. Turbulators or flappers or both may be utilized in the condenser 126 to facilitate effective heat transfer. The heated heating fluid may be utilized for heating applications such a home or building heating system, or heat upgrade system.

In use, the refrigerant, which may be water, inorganic salt water solution, alcohol, or ammonia, for example, is introduced into the evaporator 110, which is at low pressure as referred to above. The refrigerant evaporates in the evaporator 110 and the vapor travels through the fluid line 112 into the sorber bed chamber 102 where the vapor is sorbed by the sorbent material. As the refrigerant evaporates, fluid traveling through the fluid cooling line 160 is cooled as the fluid in the fluid cooling line 160 travels through the evaporator 110.

As the vapors from the refrigerant are sorbed by the sorbent material, heat is generated by the heat of sorption. The cooling fluid is introduced into the housing 108 via the first inlet line 152, the three-way inlet valve 148, and the heat exchange fluid inlet line 144 to exchange heat with the sorber bed chamber 102, to cool the sorbent material during sorption of the vapors from the refrigerant. The cooling fluid exits the housing 108 via the heat exchange fluid outlet line 146, the three-way outlet valve 150, and the first outlet line 156.

When further vapor is no longer sorbed by the sorbent material or sorption slows, the valve 114 is closed. The valve 130 in the vapor line 128 is opened. The three-way inlet valve 148 is switched to allow the regenerative fluid in from the second fluid inlet line 154, through the three-way valve 148 and the heat exchange fluid inlet line 144. The three-way outlet valve 150 is also switched to allow the regenerative fluid to flow out through the heat exchange fluid outlet line 146, through the three-way outlet valve 150, and out the second outlet line 158. Thus, the flow of the regenerative fluid is facilitated, adding low grade heat, for example, in some applications, regenerative fluid at less than 100° C. may be introduced into the housing 108, to promote desorption of the sorbed refrigerant vapor. The refrigerant vapor then travels into the condenser via the vapor line 128 where the refrigerant condenses and travels back to the evaporator via the refrigerant return line 138.

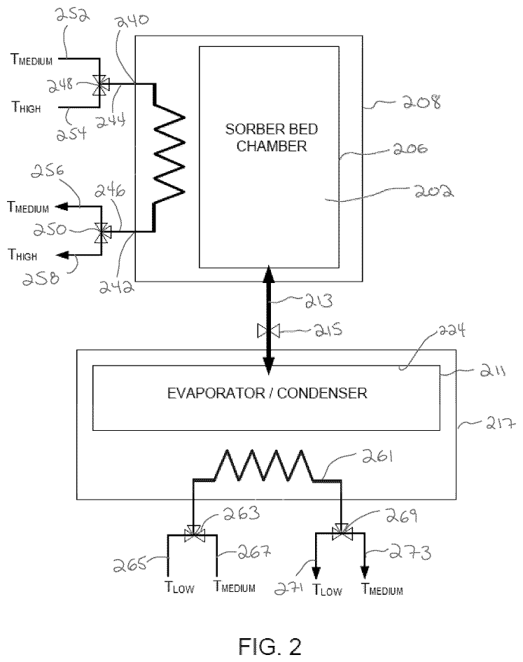

In the example described above with reference to FIG. 1, the sorption device includes an evaporator and a separate condenser. Alternatively, the evaporator and condenser may be combined. FIG. 2 shows a schematic view of an example of a sorption device 200 including a combined evaporator and condenser that includes a combined evaporator and condenser chamber 211 that is configured to perform both functions of evaporation and condensation and a housing 217.

The sorption device 200 includes a sorber chamber 202. As in the example described above with reference to FIG. 1, additional sorber bed chambers may be successfully implemented. For example, a plurality of sorber bed chambers in a single housing may be utilized. Alternatively, or in addition, multiple housings, each including one or more sorber bed chambers may be utilized.

The sorber bed chamber 202 may be similar to the sorber bed chamber as described above with reference to FIG. 1. As with the example described above, the sorber bed chamber 202 has a sorbent material fixed to an internal surface of a wall 206 thereof. The sorbent material is suitable to sorb and desorb vapor from a refrigerant. The wall 206 of the sorber bed chamber 202 may be a thin-walled material that is metallized or metal-lined or made from other materials such as graphite, polymer, ceramic, glass, with a thin coating and/or resin impregnation, or any combination thereof. Optionally, a coating may be utilized to protect the surface against corrosion and/or to modify or enhance the surface features such as contact angle. Optionally, resin impregnation may be used to seal the surface pores in porous and semi-porous wall materials such as graphite. In one example, the wall 206 of the sorber bed chamber 202 is a thin-walled metallic-polymer package or pouch. The combined evaporator and condenser chamber 211 may also have similarly constructed walls to that of the sorber bed chamber 202.

The sorber bed chamber 202 is housed in the housing 208 that extends around the sorber bed chamber 202. The wall 206 of the sorber bed chamber 202 provides a barrier between the interior of the sorber bed chamber 202 and the exterior of the sorber bed chamber. Thus, the sorber bed chamber 202 is hermetically sealed from a remainder of the interior of the housing 208 that surrounds the sorber bed chamber 202.

The sorber bed chamber 202 is fluidly coupled to the combined evaporator and condenser chamber 211 by a fluid line 213 for the flow of vapor from the combined evaporator and condenser chamber 211 into the sorber bed chamber 202 when the combined evaporator and condenser chamber 211 acts as an evaporator, and for the flow of vapor from the sorber bed chamber 202 into the combined evaporator and condenser chamber 211 when the combined evaporator and condenser 211 acts as a condenser.

The fluid line 213 extends through the housing 208 and into the sorber bed chamber 202, maintaining a seal or barrier between the operating fluid in the fluid line 213 and the remainder of the interior of the housing 208 that surrounds the sorber bed chamber 202. The fluid line 213 includes a valve 215 to control the flow of vapor between the combined evaporator and condenser chamber 211 into the sorber bed chamber 202.

The combined evaporator and condenser chamber 211 is configured to operate at a suitable pressure for evaporation of the refrigerant. The pressure may be a low pressure, i.e., a pressure well below atmospheric pressure. The pressure at which the evaporator operates at is dependent on the refrigerant utilized, operating conditions, and application. The combined evaporator and condenser chamber 211 is configured to condense the vapor from the sorber bed chamber 202 when operating as a condenser. In particular, the combined evaporator and condenser chamber 211 is configured to operate at a pressure that is suitable for the refrigerant to condense. The operating pressure in the combined evaporator and condenser chamber 211 when operating as a condenser is therefore dependent on the refrigerant operating conditions, and application.

Internal surfaces 224 of the combined evaporator and condenser chamber 211 include a surface pattern or modification to facilitate capillary action of the refrigerant within the combined evaporator and condenser chamber 211 and to facilitate drop-wise condensation when operating as a condenser. The surface pattern or modification on the internal surfaces 224 may be micro-grooves that are sized to facilitate wicking of the refrigerant, providing a capillary surface. The surface pattern may also include asymmetric bumps with surface features that provide superhydrophilicity. The grooves/bumps may be formed utilizing any suitable technique such as molding, coating, spraying, stamping, laser machining, etching, deposition, attaching structures such as micropillars, mesh, or porous medium, or a combination of these techniques.

The housing 208 around the sorber bed chamber 202 includes a heat exchange fluid inlet 240 and a heat exchange fluid outlet 242. The heat exchange fluid inlet 240 is coupled to a heat exchange fluid inlet line 244 that includes a three-way inlet valve 248 for selectively coupling the heat exchange fluid inlet line 244 to a first inlet line 252 and a second inlet line 254. The heat exchange fluid outlet 242 is coupled to a heat exchange fluid outlet line 246 that includes a three-way outlet valve 250 for selectively coupling the heat exchange fluid outlet line 246 to a first outlet line 256 and a second outlet line 258.

The first inlet line 252 and first outlet line 256 may be utilized for the flow of a cooling fluid utilized to cool the sorber bed chamber 202 during sorption of the vapor to facilitate sorption by the sorbent material as the heat of sorption is generated. The cooling fluid may be, for example, ambient air, ambient temperature water or water from a cooling tower, lake, or other source. The cooling fluid may be an ambient temperature fluid that is introduced into the housing 208 to exchange heat with the sorber bed chamber 102, to cool the sorbent material during sorption of the refrigerant vapor.

The second inlet line 254 and the second outlet line 258 may be utilized for the flow of a regenerative heat exchange fluid to heat the sorber bed chamber 202 to facilitate desorption of the refrigerant vapor from the sorbent material. The regenerative fluid utilized to heat the sorber bed chamber 202 may be waste gasses from industry, solar heated fluid, geothermal heated fluid, or any other low grade heat fluid. The regenerative fluid is therefore a gas or other low grade heat fluid that is selectively introduced into the housing 208 to heat the sorbent material in the sorber bed chamber 202. This heat exchange is utilized to facilitate desorption of the refrigerant from the sorbent material in the sorber bed chamber 202, thus regenerating the sorbent material to receive more vapor.

A fluid cooling and heating line 261 is shown in FIG. 1 and extends through a housing 217 around the combined evaporator and condenser chamber 211 for heat exchange with the refrigerant. The fluid cooling and heating line 261 includes an inlet cooling and heating valve 263 for selectively coupling the fluid cooling and heating line 261 to a first fluid inlet line 265 for the introduction of fluid for cooling when the evaporator and condenser chamber 211 operates as an evaporator, and to a second fluid inlet line 267 for the introduction of a fluid for heating when the evaporator and condenser chamber 211 operates as a condenser.

Similarly, the fluid cooling and heating line 261 includes an outlet cooling and heating valve 269 for selectively coupling the fluid cooling and heating line 261 to a first fluid outlet line 271 for the cooling fluid to exit the housing 217 after being cooled when the evaporator and condenser chamber 211 operates as an evaporator, and to a second fluid outlet line 273 for the heated fluid to exit the housing 217 after heating when the evaporator and condenser chamber 211 operates as a condenser.

In use, the refrigerant, which may be water, inorganic salt water solution, alcohol, or ammonia, for example, in the combined evaporator and condenser 211 evaporates under low pressure as described above. The vapor travels through the fluid line 213 into the sorber bed chamber 202 where the vapor is sorbed by the sorbent material. As the refrigerant evaporates, the inlet cooling and heating valve 263 and the outlet cooling and heating valve 269 are set to facilitate the flow of the fluid for cooling from the first fluid inlet line 265 and out the first fluid outlet line 271. The fluid for cooling travels through the housing 217, is cooled, and, after exiting the combined evaporator and condenser 211 may be utilized for cooling applications.

As the vapors from the refrigerant are sorbed by the sorbent material, heat is generated by the heat of sorption. The three-way inlet valve 248 is utilized to couple the heat exchange fluid inlet line 244 to a first inlet line 252 and the three-way outlet valve 250 is utilized to couple the heat exchange fluid outlet line 246 to a first outlet line 256. Cooling fluid is thereby circulated through the housing 208, to cool the sorbent material as the heat is generated.

When further vapor is no longer sorbed by the sorbent material or sorption slows, the three-way inlet valve 248 is utilized to couple the heat exchange fluid inlet line 244 to a second inlet line 254 and the three-way outlet valve 250 is utilized to couple the heat exchange fluid outlet line 246 to the second outlet line 258. Regenerative fluid is thereby circulated through the housing 208, to heat the sorbent material, promoting desorption of the sorbed refrigerant vapor. The refrigerant vapor then travels into the combined evaporator and condenser chamber 211 where the refrigerant condenses. The process is continuously repeated for heating and/or cooling applications.

Alternatively, the sorption device 200 may be utilized for thermal storage. Low grade heat fluid is circulated through the housing 208 to facilitate desorption of sorbed refrigerant vapor. The low-grade heat fluid may optionally be waste gases, for example, or any other suitable low grade heat fluid. The refrigerant vapor then travels into the combined evaporator and condenser chamber 211 where the refrigerant condenses. After desorption, i.e., little or no refrigerant remains sorbed by the sorbent material, the valve 215 is closed.

The sorbent material in the sorber bed chamber 202 is therefore ready to sorb refrigerant vapor. The sorber bed chamber 202 is hermetically sealed with the valve 215 closed and the sorber bed chamber remains in the state in which the sorbent material is ready to sorb refrigerant vapor. Thus, the sorption device 200 remains in a state in which the combined evaporator and condenser chamber 211 is ready to act as an evaporator and thus ready to cool fluid for cooling that flows through the fluid cooling and heating line 261. Thus, the sorption device 200 is ready to cool fluid that may be utilized in cooling applications.

Alternatively, the sorbent material in the sorber bed chamber 202 may be sealed with the valve 215 closed when the sorbent material has sorbed vapor and is ready to desorb vapor with the introduction of the regenerative fluid. In this state, the combined evaporator and condenser chamber 211 is ready to act as a condenser and thus ready to heat fluid that flows through the cooling and heating line 261. Thus, the sorption device is ready to heat fluid that may be utilized in heating applications.

The sorption device 200 is therefore effectively utilized as a thermal battery or for thermal storage as the sorption device 200 may remain in a state in which it is ready to generate heating fluid or cooling fluid. Such a system, in a ready state, also referred to as charged state, to heat or cool fluid, may be moved or transferred to a location for use, facilitating the movement of the heating or cooling energy.

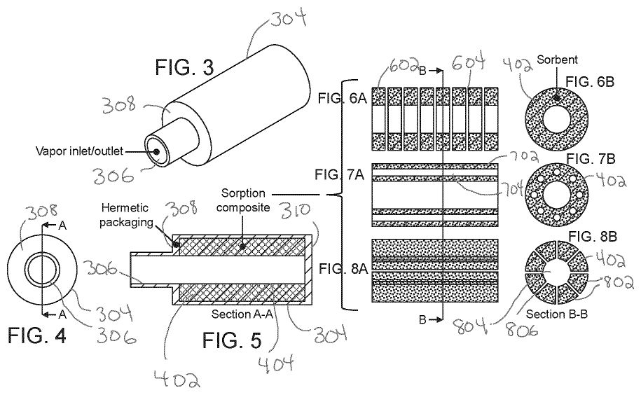

One example of a sorber bed chamber that may be utilized with the examples shown in FIG. 1 or FIG. 2 is shown in FIG. 3 through FIG. 5. In the present example, the sorber bed is generally cylindrically shaped, including a cylindrical body 304 in which the sorbent material 402 is housed within the cylindrical body 304. A cylindrical inlet 306 extends from a center of one end 308 of the cylindrical body 304 and has a diameter that is smaller than the cylindrical body 304. Thus, the body 304 and the inlet 306 are aligned along their central axes.

The body 304 provides a hermetic package. The body 304 may be made from thin wall that is metallized or metal-lined or made from other materials such as graphite, polymer, ceramic, glass, with thin coating and/or resin impregnation, or any combination thereof. Optionally, a coating may be utilized to protect the surface against corrosion and/or to modify or enhance the surface features such as contact angle. Optionally, resin impregnation may be used to seal the surface pores in porous and semi-porous wall materials such as graphite. For example, a thin film of ceramic or polymer-metal foil laminate. The body 304 is bonded or sealed at the ends 308, 310 to provide a barrier that is sealed and corrosion-resistant. Utilizing the thin film body, the mass of the sorber bed chamber is significantly lower than that of a body of, for example, heavy-gauge, corrosion-resistant stainless steel chambers.

The sorbent material 402 in the present example is generally cylindrical with a center bore 404 that is aligned with the cylindrical inlet 306 and has the same or similar interior diameter as the cylindrical inlet 306, facilitating the flow of vapor into and out of the sorber bed chamber.

As described above, the sorbent material 402 is highly porous and has a high thermal conductivity, low density, and low specific heat. For example, the sorbent material 402 may have a specific pore volume of >1 cm³/g and specific surface area of >300 m²/g. The thermal conductivity may be greater than 0.2 W/mK. In some examples, the thermal conductivity may be greater than 1.5 W/mK. The sorbent material may include a solid sorbent, a binder material, hygroscopic salt, and a conductive additive. The sorbent material 402 has high gas diffusivity to facilitate permeation of the vapor into and out of the sorbent material 402. In one example, the solid sorbent of the sorbent material 402 includes a highly porous matrix of, for example, silica gel. The host matrix is impregnated by hygroscopic salts such as calcium chloride and is loaded with one or more types of suitable thermally conductive additive material such as graphite flakes, treated and modified expanded natural graphite, graphite worms, carbon nanotubes, or a combination thereof. A binder material of organic glue, inorganic glue, or liquid glass may be utilized to bind the elements together into a composite. In one example, a binder of Polyvinylpyrrolidone 40 (PVP40), is utilized to bind the elements together into a composite.

The sorbent material 402 may be fixed to the internal surface of the cylindrical wall of the body 304. A glue, such as PVP40, may be utilized to fix the sorbent material to the internal surface of the wall of the body 304, between the ends 308, 310. Alternatively, the sorbent material may be directly deposited or synthesized on the internal surface of the cylindrical wall of the body 304. The attachment of the sorbent material to the body 304 provides direct contact and reduces thermal resistance, i.e., improves thermal conductivity, compared to the use of a sorbent material that is not adhered. Alternatively, the sorbent material 402 may be, for example, in beads or loose particles or grain that are included in the body 304 such that the sorbent material is disposed on or rests on the internal surface of the cylindrical wall of the body 304 but is not fixed thereto.

The sorbent material 402 may be several micrometers to centimeters in thickness on the cylindrical internal surface of the wall of the body 304, providing a significant volume of sorbent material 402 capable of sorbing refrigerant vapor and thus providing significant release of heat from the heat of sorption.

FIG. 6A and FIG. 6B illustrate one example of a sorbent material 402. In this example, the sorbent material 402 is formed in discs 602 with center holes. The sorbent material may be formed into the discs 602 in any suitable manner. For example, the discs may be formed by mixing sorbent, glue, and water and heating in a mold to remove water therefrom. The discs 602 may be glued within the body 304 as described above, and spaced apart to provide gaps 604 or grooves between the discs 602. The center holes of the discs 602 are aligned with the interior of the inlet 306 coupled to and forming a seal with the cylindrical body 304. The gaps 604 between the discs 602 facilitate sorption of the vapor by the sorbent material 402 as the vapor enters the sorber bed chamber through the inlet 306 and travels along the center holes of the discs and through the gaps 604. A reinforcing structure such as a mesh may be utilized across length of the cylinder to reinforce the discs.

FIG. 7A and FIG. 7B show another example of a sorbent material 402. In this example, the sorbent material is formed into a cylinder 702 with a center hole. The cylinder 702 also includes holes 704 or grooves extending along the length of the cylinder, generally parallel to a central axis of the cylinder 702 and generally evenly spaced at a same radial distance from the central axis. The cylinder 702 is fixed within the body 304 as described above. The holes 704 also facilitate sorption of the vapor by the sorbent material 402. As in the above example, a reinforcing structure such as a mesh may be utilized across length of the cylinder 702.

FIG. 8A and FIG. 8B show yet another example of a sorbent material 402. In this example, the sorbent material is formed into wedges 802 or sections that are fixed to the internal surface of the cylindrical wall of the body 304. The wedges 802 are sized and shaped to generally form a cylinder that includes a center hole 804 that is aligned with the inlet 306, and gaps 806 or grooves that extend radially outwardly from the center hole 804. The gaps 804 facilitate sorption of the vapor by the sorbent material 402 as the vapor enters the sorber bed chamber through the inlet 306 and travels along the center hole 804 and through the gaps 806. A reinforcing structure such as a mesh may be utilized across length to provide reinforcement for the wedges.

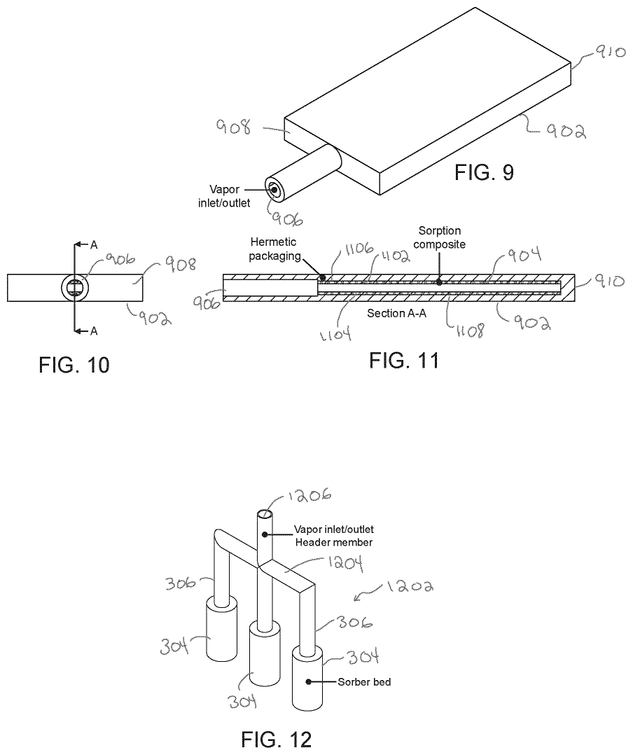

Another example of a sorber bed chamber that may be utilized with the examples shown in FIG. 1 or FIG. 2 is shown in FIG. 9 through FIG. 11. In the present example, the sorber bed chamber has a body 902 that is generally rectangular box shaped. The sorbent material 904 is housed within the body 902. A cylindrical inlet 906 extends from a center of one end 908 of the body 902.

As with the example described above with reference to FIG. 3 through FIG. 5, the body 902 provides a hermetic package or pouch. The body 902 may be made from similar materials to that described above with reference to FIG. 3 through FIG. 5 and is bonded or sealed at the ends 908, 910 to provide a barrier that is corrosion resistant. Utilizing the thin film body, the mass of the sorber bed chamber is significantly lower than that of a body of, for example, heavy-gauge, corrosion-resistant stainless steel.

The sorbent material 904 in the present example is generally plate shaped, with a first plate 1102 fixed to an inner surface 1106 of the generally rectangular box shaped body 902 and a second plate 1104 fixed to an opposing inner surface 1108 of the body 902. The first plate 1102 and the second plate 1104 are spaced apart to facilitate the flow of vapor into the body and sorption of the vapor. Alternatively, grooves may be included inside the sorption composite blocks to facilitate vapor flow.

The sorbent material 904 may be similar to the sorbent material 402 described above and is therefore not described again. The sorbent material 904 may be formed into the first plate 1102 and the second plate 1104 and then fixed to the respective one of the inner surface 1106 and the opposing inner surface 1108 by, for example a glue such as PVP40, or may be directly deposited or synthesized on the inner surfaces 1106, 1108.

Each of the plates 1102, 1104 may be several micrometers to centimeters in thickness providing a significant volume of sorbent material 904 capable of sorbing vapor and thus providing significant release of heat from the heat of sorption.

A bundle of sorber bed chambers is shown in FIG. 12. In this example, the sorber bed chambers are similar to those described above with reference to FIG. 3 through FIG. 5, including the cylindrical body 304 in which the sorbent material 402 is housed, and the cylindrical inlet 306. In this example, the bundle 1202 includes a three sorber bed chambers in parallel arrangement with the cylindrical inlet 306 of each fluidly coupled to a header 1204 that includes a header inlet 1206. The header inlet 1206, the header 1204, the cylindrical inlet 306, and the cylindrical body 304 together are sealed to provide a fluid flow path, for the flow of the vapor into and out of the sorber bed chambers while maintaining a hermetic seal.

Although shown as relatively short sorber bed chambers in FIG. 12, longer cylindrical or rectangular tubes may be utilized. For longer tubes, for example, a tube bundle in a bundle reactor, supports may be included to maintain the sorber bed chambers in place and inhibit “sagging” and to facilitate heat transfer with the heat transfer fluid. For example, baffles may be included to support the sorber bed chambers. Optionally, flappers and turbulators may be installed on the exterior of the cylindrical or rectangular tubes to enhance the heat transfer rate with the heat transfer fluid.

The bundle 1202 provides three sorber bed chambers for the sorption and desorption of vapor. Other numbers of sorber bed chambers may be utilized, however. For example, the number of sorber bed chambers may be significantly greater than the 3 sorber bed chambers shown. Thus, the number of sorber bed chambers may be determined based on the application, facilitating scalability where greater sorption is desirable for larger applications.

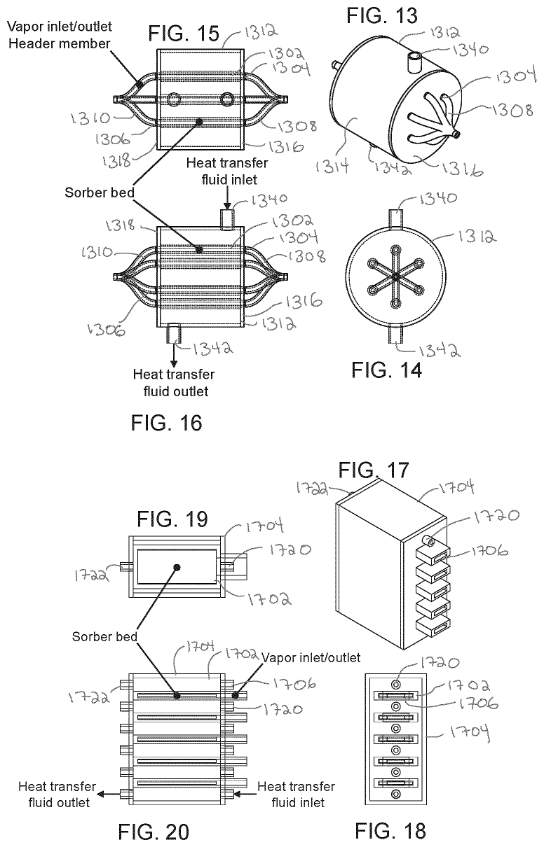

FIG. 13 through FIG. 16 show an example of a bundle of sorber bed chambers housed in a cylindrical housing. In the present example, 6 sorber bed chambers are utilized. Each sorber bed chamber includes a cylindrical body 1302 that includes an inlet 1304 at one end thereof and an outlet 1306 at an opposing end thereof. The sorbent material is housed in the cylindrical body 1302 of each sorber bed chamber. The inlets 1304 of the 6 cylindrical bodies are joined together at an inlet header 1308 and the outlets 1306 are joined together at an outlet header 1310.

The inlet header 1308 may be fluidly coupled to an evaporator such as the evaporator 110 referred to above. The outlet header 1310 may be fluidly coupled to a condenser such as the condenser 126 referred to above. Thus, in the present example, vapor that is sorbed by the sorbent material enters the cylindrical body 1302 at one end thereof, and vapor that is desorbed from the sorbent material exits the cylindrical body 1302 at the opposing end.

The housing 1312 in the present example is generally cylindrical and extends around the 6 cylindrical bodies 1302 of the sorber bed chambers. The cylindrical wall 1314 of the housing 1312 is spaced from the cylindrical bodies 1302 to provide a cavity within the housing 1312 and within which a heat exchange fluid may flow for indirect heat exchange with the sorbent material. In this example, the cylindrical bodies 1302 are generally distributed at a same radial distance from a central axis of the housing 1312. The inlet header 1308 extends from one end 1316 of the housing 1312 and the outlet header 1310 extends from an opposing end 1318 of the housing 1312.

The housing 1312 includes a heat exchange fluid inlet 1340 for selectively coupling via a three-way inlet valve to a first and second inlet lines. The housing 1312 also includes a heat exchange fluid outlet 1342 four selectively coupling via a three-way outlet valve to a first and second outlet lines.

Utilizing the heat exchange fluid inlet 1340 and the heat exchange fluid outlet 1342, a cooling fluid may be introduced to cool the sorbent material of the sorber beds during sorption of vapor. A regenerative fluid may also be introduced to facilitate desorption of vapor.

In the example shown in FIG. 13 through FIG. 16, 6 sorber bed chambers are shown. Any suitable number of sorber bed chambers may be utilized, however. In addition, the size of the housing 1312 may be selected to provide an appropriate housing for the number of sorber bed chambers housed therein and for the flow of the heat transfer fluid therein. Further, more than one housing with a plurality of sorber bed chambers housed therein may be utilized. Thus, the number of housings, the size of the housing(s), and the number of sorber bed chambers may be determined based on the application, providing scalability for different applications.

In addition, both an inlet header 1308 fluidly coupled to an evaporator, and an outlet header 1310 fluidly coupled to a condenser are described with reference to FIG. 13 through FIG. 16. Alternatively, the bundle of sorber bed chambers may include only one header that operates as both an inlet header and an outlet header. The opposing ends of the sorber bed chambers may be capped or a header at the opposing end may be capped. Thus, a single header may be utilized for the vapor to flow into and out of the sorber bed chambers.

Optionally, rather than capping an opposing end of the sorber bed chambers or header, the opposing end may be utilized for connecting a further bundle of sorber bed chambers.

FIG. 17 through FIG. 20 show another example of a bundle of sorber bed chambers housed in a housing. In the present example, 5 sorber bed chambers are utilized. Each sorber bed chamber includes a body 1702 that is generally rectangular box shaped, similar to the example described above with reference to FIG. 9 through FIG. 11. In the present example, however, the inlet is not cylindrical but is generally rectangular parallelepiped in shape and acts as an inlet/outlet 1706. The sorbent material is housed within the body 1702 similar to that described above.

In the present example, the bodies 1702 are stacked parallel to each other in a spaced-apart arrangement. The inlet/outlets 1706 of the sorber bed chambers are not joined together in the example shown in FIG. 17 through FIG. 20. The inlet/outlets may optionally be joined by a header or may be separately connected to an evaporator and condenser. Each body 1702 is fluidly connected to and sealed to a single inlet/outlet 1706. The inlet/outlet 1706 of each body 1702 may be connected to a combined evaporator and condenser or may be coupled to both an evaporator and a separate condenser.

The housing 1704 is also generally rectangular box shaped and extends around the 5 bodies 1702 and is spaced from the bodies 1702 to facilitate the flow of heat exchange fluid within the housing 1704, between the housing 1704 and the bodies 1702. For the purpose of this example, the housing 1704 includes 6 heat exchange fluid inlets 1720 on a same side of the housing 1704 as the inlet/outlet 1706 for each of the sorber bed chambers such that each inlet/outlet 1706 is sandwiched by a pair of heat transfer fluid inlets 1720. Six heat exchange fluid outlets 1722 are disposed on an opposing side of the housing 1704 to promote flow of the heat exchange fluid, which may be a cooling fluid, across the housing 1704 and over the surfaces of each body 1702 to which the sorbent material is fixed. The heat exchange fluid inlets 1720 and the heat exchange fluid outlets 1722 may also be utilized for the flow of a regenerative fluid within the housing to regenerate the sorbent material in the sorber bed chambers by causing desorption of the vapor.

In the example shown, 5 sorber bed chambers are shown. Any suitable number of sorber bed chambers may be utilized, however. In addition, the size of the housing 1704 may be selected to provide an appropriate housing for the number of sorber bed chambers housed therein and for the flow of the heat exchange fluid therein. Further, more than one housing with a plurality of sorber bed chambers housed therein may be utilized. Thus, the number of housings, the size of the housing(s), and the number of sorber bed chambers may be determined based on the application, providing scalability for different applications.

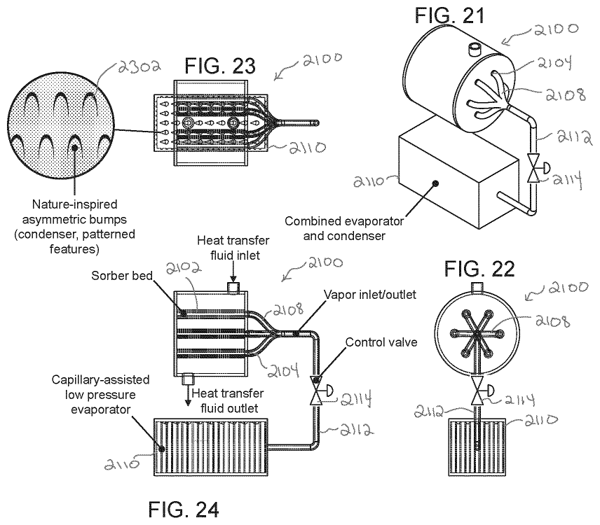

An example of a sorption device is shown in FIG. 21 through FIG. 24 and is indicated generally by the numeral 2100. In this example, the bundle of sorber bed chambers, which includes 6 sorber bed chambers, and the generally cylindrical housing are similar to that described with reference to FIG. 13 through FIG. 16 in that each sorber bed chamber includes a cylindrical body 2102. Rather than a separate inlet and outlet, however, the cylindrical body is fluidly coupled and sealed to a combined inlet/outlet 2104. The combined inlet/outlets 2104 are joined together by an inlet/outlet header 2108 that is fluidly coupled to a combined evaporator and condenser 2110 by a fluid line 2112 that includes a valve 2114 therein for controlling the flow of vapor into and out of the sorber bed chambers.

The combined evaporator and condenser 2110 includes micro-grooves and or other surface features such as bumps, wicks, mesh with coating or the combination thereof in a surface thereof to facilitate wicking of the refrigerant when the combined evaporator and condenser 2110 acts as an evaporator.

The combined evaporator and condenser 2110 may also include a surface pattern, which in this example includes asymmetric bumps 2302 to facilitate drop-wise condensation of the vapor when the combined evaporator and condenser 2110 acts as a condenser.

Many of the features or elements of the sorption device 2100 may vary. For example, the sorber bed chambers may end in a tube sheet to which the sorber bed chambers are coupled. The inlet/outlet header 2108 may be a tube sheet cap coupled to the fluid line 2112 and through which the fluid is transferred into and out of the sorber bed chambers. In addition, any suitable number of sorber bed chambers may be utilized. Baffles may also be included in the body 2102 to support the sorber bed chambers and to enhance heat transfer and to facilitate flow of heat exchange fluid around the sorber bed chambers.

The remaining features or elements as well as the operation of the sorption device 2100 is similar to that shown and described with reference to FIG. 2, with the exception that the example shown in FIG. 21 includes six sorber bed chambers rather than a single sorber bed chamber as shown in FIG. 2. The additional sorber bed chambers increase the volume of vapor sorbed and increase the total heat generated as a result of the heat of sorption.

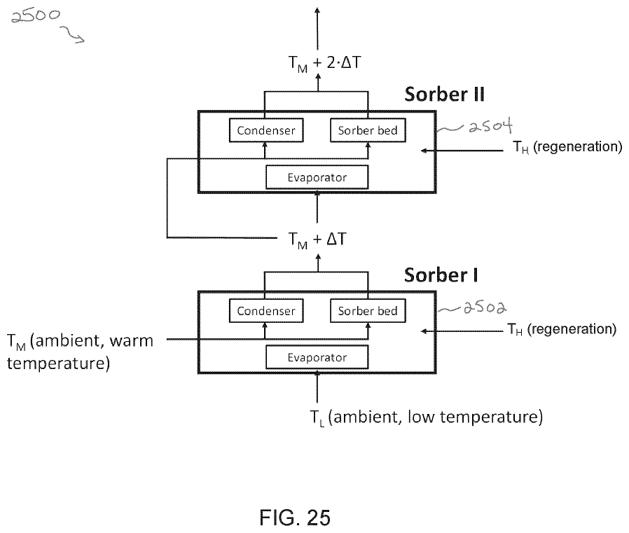

FIG. 25 illustrates an example of a combination 2500 of sorption devices 2502, 2504. In this example, the combination 2500 of sorption devices 2502, 2504 may be utilized for heat upgrading. In the present example, two or more sorption devices 2502, 2504, each include a sorber bed chamber and evaporator and condenser, which alternatively may be a combined evaporator and condenser. The two or more sorption devices 2502, 2504 are utilized in a cascading arrangement to increase the temperature in the output of the combination 2500. In this example, the outlet of the first sorption device 2502 is connected to the second sorption device 2504, to increase refrigerant vapor pressure, facilitating increased heating during sorption in this and optional further sorption devices.

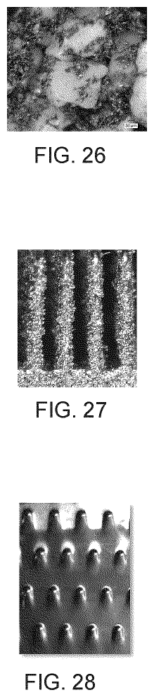

An example of a sorbent material for use in a sorption device is shown in FIG. 26. In this example, the sorbent material is a CaCl₂)-silica gel composite sorbent infused with expanded natural graphite or modified expanded natural graphite. As described hereinabove, a binder or glue of PVP40 is utilized.

In a particular example, a sorbent material of, for example, silica gel (B300) 58%; CaCl₂): 25%; Expanded natural graphite: 8%; PVA: 9%, may be utilized. The sorbent material may be prepared in any suitable manner. The sorbent may be prepared by mixing binder with distilled water and a temperature of, for example, about 95° C. until the binder is fully dissolved. For example, the binder and distilled water way be mixed for about 1 to about 2 hours. Dry CaCl₂) is added to the binder solution and mixed, for example, for about 20 minutes until the CaCl₂) salt is dissolved. A thermal additive of, for example, expanded natural graphite is added to the solution and sonicated in a sonic back, for example, for about 30 minutes and stirred repetitively, for example, for about 2 hours. Silica gel matrix such as B300 is added to the mixture and mixed for about 30 minutes. The mixture is then transferred to a flat dish and evaporated to reach a consistency suitable for molding. The resulting composite is transferred to a mold of suitable shape for the application and dried in the oven, gradually increasing the temperature, for example, from about 80° C. to about 100° C. and then cured at, for example about 130° C. for about 2 hours.

The sorbent material may be formed into rings or discs with center holes as illustrated in FIGS. 6A and 6B, for example, for loading into the sorber bed chamber. These discs may be manufactured with desired thicknesses based on the application. In one example, discs having a radial wall thickness of about 3.5 mm were formed utilizing the sorbent material and method described above and loaded into sorber bed chamber shown in FIG. 3 connected to a combined evaporator and condenser.

Experimental results from one example result cycling showed an average specific cooling power at 70% material capacity (SCP-70%) of 270 [W/kg], SCP-70% is defined as:

$$SCP - 70 \% [ \frac{W}{kg} ] = \frac{0.7 \cdot Δω \cdot Δ {H}_{{T}_{evap}}}{{τ}_{70 \%}}$$

where, Δω [g/g]—maximal material (composite) water uptake capacity under test cycle conditions, ΔH_{T}_{ₑᵥₐₚ} [J/g]—enthalpy of evaporation (here it is water) at Tₑᵥₐₚ=15° C., τ_{70%} [s]—characteristic time of material reaching 70% of its maximal uptake capacity.

From one example, the average specific fooling power after 5 minutes of sorption process (SCP-5 min) was 343 [W/kg], SCP-5 min is defined as:

$$S C P - 5 min [ \frac{W}{kg} ] = \frac{Δ {ω}_{5 m i n} \cdot Δ {H}_{{T}_{evap}}}{{τ}_{sorp}} ,$$

where, τₛₒᵣₚ [s]—sorption duration (5 minutes here), Δω_{5 min} [g/g]—sorption composite water uptake after τₛₒᵣₚ time (5 minutes here).

From one example, the maximum specific energy storage under test cycle conditions was 0.97 [MJ/kg], the definition of specific energy storage is defined as:

$$SP [ \frac{J}{kg} ] = \frac{sorption energy}{sorbent mass} = \frac{Δω \cdot {m}_{sorbent} \cdot Δ {H}_{sorp}}{{m}_{sorbent}} = Δω \cdot Δ {H}_{sorp}$$

where ΔHₛₒᵣₚ [J/g] is the sorption heat generation of the material when ad/absorbing water.

The above experimental results illustrate the performance of a sorption device in a particular test environment and changes and modifications may be effected and improvements in results may be realized.

An example of a surface of an evaporator or a combined evaporator/condenser is shown in FIG. 27, in which a stainless steel is 3-D printed with 100 micron groves and surface structure to enhance wicking and thereby improve evaporation. The specific evaporation rate in an evaporator including the surface structure shown is increased significantly over the specific evaporation of an evaporator that does not include such surface structure.

An example of a surface of a condenser or a combined evaporator/condenser is shown in FIG. 28, in which the surface includes asymmetric bumps formed thereon. The condensation rate in a condenser including the asymmetric bumps shown is increased by a significant amount over the condensation rate in condenser that does not include the asymmetric bumps.

Advantageously, the thin-walled, or thin film external wall of the sorber bed chamber provides light weight, effective heat transfer through the wall, between the sorbent material and a heat transfer fluid in a housing surrounding the sorber bed chamber. Therefore, the sorbent (active) material to inactive material ratio is substantially higher compared to existing sorber beds, leading to improved coefficient of performance for the system. In addition, the sorption device is scalable as any suitable number of sorbent beds and any suitable number of housings with any suitable number of sorbent beds in each may be successfully employed.

The sorbent device facilitates effective storage of thermal energy, referred to as thermal storage or thermal battery by maintaining the sorbent material in a desorbed state and ready to sorb vapor from a refrigerant and to therefore release heat of sorption to provide heating or cooling.

The evaporator including a surface treatment or coating to facilitate wicking of the refrigerant, significantly increases the vaporization rate of the refrigerant. In addition, the condenser, which may be combined with the evaporator or may be a separate element, includes a surface treatment or coating that facilitates drop-wise condensation of the refrigerant therein.

The sorption device may be cycled frequently and continuously to generate heat or cooling fluid for use in heating or cooling or heat upgrading. A controller may be utilized to effectively cycle through evaporation and condensation quickly. Artificial intelligence techniques may be successfully employed to control the cycling through the evaporation and condensation cycles effectively and efficiently to provide effective heating or cooling.

The scope of the claims should not be limited by the preferred embodiments set forth in the examples but should be given the broadest interpretation consistent with the description as a whole.

1. A sorption device comprising:
a sorber bed chamber having a sorbent material disposed therein and configured to sorb and desorb vapor from a refrigerant, the sorber bed chamber configured to exchange heat with a regenerative fluid to effect desorption of the refrigerant from the sorbent material;
an evaporator and condenser fluidly coupled to the sorber bed chamber and configured to evaporate the refrigerant for sorption by the sorbent material of the sorber bed and configured to condense vapor from the sorbent material of the sorber bed;
wherein the sorber bed chamber, the evaporator and condenser are configured to provide a sealed refrigerant flow path.

2. The sorption device according to claim 1, wherein the sorbent material is fixed on an internal surface of a wall of the sorber bed chamber.

3. The sorption device according to claim 1, wherein the evaporator and condenser comprise a dual function device configured to facilitate evaporation and condensation.

4. The sorption device according to claim 1, wherein the evaporator and condenser comprise an evaporator fluidly coupled to the sorber bed chamber for the flow of vapor from the evaporator into the sorber bed chamber for sorption by the sorbent material, and a separate condenser fluidly coupled to the sorber bed chamber for the flow of vapor desorbed from the sorbent material into the condenser to regenerate the sorbent material.

5. The sorption device according to claim 3, wherein the condenser is fluidly coupled to the evaporator for the flow of the refrigerant from the condenser after condensation, to the evaporator.

6. The sorption device according to claim 1, comprising a plurality of sorber bed chambers, each of the sorber bed chambers fluidly coupled to the evaporator and condenser and having a sorbent material fixed on respective internal surfaces of walls thereof.

7. The sorption device according to claim 1, wherein the sorbent material comprises a solid sorbent, hygroscopic salt, a binder material, and a conductive additive.

8. The sorption device according to claim 7, wherein a structural reinforcement is utilized with the sorbent material.

9. The sorption device according to claim 7, wherein the solid sorbent comprises at least one of silica gel, activated carbon, metal-organic framework solid sorbent, zeolite, aluminophosphate, metal substituted aluminophosphates, vermiculate, aluminum oxide materials and their composites with inorganic salts, or any combination thereof.

10. (canceled)

11. (canceled)

12. (canceled)

13. The sorption device according to claim 2, wherein the sorbent material is directly deposited or synthesized on the internal surface of the wall of the sorber bed chamber.

14. The sorption device according to claim 1, wherein the regenerative fluid comprises a hot gas, waste gas or fluid.

15. The sorption device according to claim 1, wherein the sorber bed chamber is housed in a housing configured to receive heat transfer fluid that flows through the housing, outside the sorber bed chamber to facilitate indirect heat exchange with the sorber bed chamber.

16. (canceled)

17. The sorption device according to claim 1, wherein the sorber bed chamber comprises a thin film of ceramic or polymer-metal foil laminate.

18. The sorption device according to claim 1, wherein the evaporator and condenser comprises thin-walled metal, graphite, polymer, ceramic, or any combination thereof.

19. The sorption device according to claim 1, wherein the sorbent material is shaped into cylinders or discs within the sorber bed chamber, the cylinders or discs having a respective cylindrical hole extending therethrough to facilitate diffusion of the vapor from the refrigerant.

20. (canceled)

21. (canceled)

22. The sorption device according to claim 1, wherein an internal surface of the evaporator includes a capillary surface pattern or modification to facilitate capillary action and evaporation of the refrigerant.

23. (canceled)

24. The sorption device according to claim 1, wherein an internal surface of the condenser includes a condenser surface pattern or modification to facilitate drop-wise condensation of the refrigerant.

25. (canceled)

26. The sorption device according to claim 1, comprising a plurality of control valves configured to control the flow of vapor into and out of the sorber bed chamber and to control the flow of the refrigerant and heat transfer fluids.

27. (canceled)

28. (canceled)

29. The sorption device according to claim 1, wherein the evaporator and condenser includes a combined evaporator and condenser chamber used in a housing configured to receive heat transfer fluid that flows through the housing, outside the combined evaporator and condenser chamber to facilitate indirect heat exchange with fluid in the combined evaporator and condenser chamber.

30. The sorption device according to claim 1, wherein one or both of turbulators and flappers are utilized in association with one or more of the sorber bed chamber, and the evaporator and condenser to facilitate effective heat transfer.
